(19) United States
(12) Patent Application Publication
(10) Pub. No.: US 2016/0328065 A1
(43) Pub. Date: Nov. 10, 2016

(54) Touchscreen with Dynamic Control of Activation Force

(71) Applicants: Ricky J. Johnson, Shellsburg, IA (US); Tracy J. Barnidge, Marion, IA (US); Joseph L. Tchon, Cedar Rapids, IA (US)

(72) Inventors: Ricky J. Johnson, Shellsburg, IA (US); Tracy J. Barnidge, Marion, IA (US); Joseph L. Tchon, Cedar Rapids, IA (US)

(73) Assignee: ROCKWELL COLLINS, INC., Cedar Rapids, IA (US)

(21) Appl. No.: 14/703,614

(22) Filed: May 4, 2015

(51) Int. Cl. G06F 3/041; G06F 3/0354

(52) U.S. Cl. CPC G06F 3/0414; G06F 3/03545

(57) ABSTRACT

A method includes receiving touch location data obtained from a touchscreen sensor of a touchscreen display device, the touch location data including information of a location of a user's touch or near touch of a user interfaceable surface of the touchscreen display device. The method also includes receiving force data obtained from a force sensor, the force data including information of an amount of force detected by the force sensor. The method further includes performing an operation based on the touch location data and the force data.

### CROSS-REFERENCE TO RELATED APPLICATIONS

The present application expressly incorporates herein in their entirety U.S. patent application Ser. No. 13/550,277, filed on Jan. 12, 2015, U.S. Pat. No. 8,816,578, issued on Aug. 26, 2014, and U.S. Pat. No. 8,723,809, issued on May 13, 2014.

### BACKGROUND

Touchscreen activation force can be problematic in avionics touchscreen displays. In many cases, a relatively high force for graphical user interface (GUI) button selections is required to reduce inadvertent activations. For gesturing, however, little or no actual force may be desirable so as to allow smooth and easily executed gestures. Resistive touchscreens require a relatively high activation force that is suitable for GUI buttons, but resistive touchscreens are problematic for performing gestures, such as pinch, zoom, and rotate because resistive touchscreens require an amount of touchscreen activation force that is difficult for a user to apply while performing a gesture. Additionally, capacitive and beam interrupt touchscreens which require zero activation force are suitable for gesturing; however, zero activation force is typically not desirable for GUI button selections in avionics touchscreen display applications as it may result in unintended GUI selections or activation.

Further, activation forces of current resistive touchscreens are location dependent. For example, when a currently implemented resistive touchscreen display is touched near the edge, the activation force is significantly higher than an activation touch force located near the center of the touchscreen display. Such high required activation forces near the edges of current resistive touchscreens make edge selections difficult for users.

### SUMMARY

In one aspect, embodiments of the inventive concepts disclosed herein are directed to a system including a touchscreen sensor of a touchscreen display device, at least one force sensor, a display element of the touchscreen display device, and at least one processing element. The at least one processing element is configured to receive touch location data obtained from the touchscreen sensor, the touch location data including information of a location of a user's touch or near touch of a user-interfaceable surface of the touchscreen display device. The at least one processing element is also configured to receive force data obtained from the at least one force sensor, the force data including information of an amount of force detected by one or more of the at least one force sensor. The at least one processing element is further configured to perform at least one operation based at least on the touch location data and the force data.

In another aspect, embodiments of the inventive concepts disclosed herein are directed to a method. The method includes receiving touch location data obtained from a touchscreen sensor of a touchscreen display device, the touch location data including information of a location of a user's touch or near touch of a user-interfaceable surface of the touchscreen display device. The method also includes receiving force data obtained from a force sensor, the force data including information of an amount of force detected by the force sensor. The method further includes performing an operation based on the touch location data and the force data.

In a further aspect, embodiments of the inventive concepts disclosed herein are directed to a method. The method includes providing at least one processing element configured to: receive touch location data obtained from a touchscreen sensor of a touchscreen display device, the touch location data including information of a location of a user's touch or near touch of a user-interfaceable surface of the touchscreen display device; receive force data obtained from at least one force sensor, the force data including information of an amount of force detected by one or more of the at least one force sensor; and perform at least one operation based on the touch location data and the force data. The method also includes providing the touchscreen sensor. The method further includes providing the at least one force sensor. The method additionally includes providing a display element.

Additional embodiments are described in the application including the claims. It is to be understood that both the foregoing general description and the following detailed description are exemplary and explanatory only and are not restrictive. Other embodiments will become apparent.

### BRIEF DESCRIPTION OF THE FIGURES

Other embodiments will become apparent by reference to the accompanying figures in which:

FIG. 1 shows a cross-sectional diagram of a portion of a touchscreen display device of one embodiment;

FIG. 2A depicts a cross-sectional diagram of a portion of a touchscreen display device of one embodiment;

FIG. 2B depicts a cross-sectional diagram of a portion of a touchscreen display device of one embodiment;

FIG. 2C depicts a cross-sectional diagram of a portion of a touchscreen display device of one embodiment;

FIG. 2D depicts a cross-sectional diagram of a portion of a touchscreen display device of one embodiment;

FIG. 2E depicts a cross-sectional diagram of a portion of a touchscreen display device of one embodiment;

FIG. 3A depicts a diagram of a top, cross-section of a portion of a touchscreen display device of one embodiment;

FIG. 3B depicts a diagram of a top, cross-section of a portion of a touchscreen display device of one embodiment;

FIG. 4 depicts a diagram of a system of one embodiment;

FIG. 5 depicts an exemplary data structure of one embodiment;

FIG. 6 depicts a view of an exemplary graphical user interface (GUI) displayed by a touchscreen display device of one embodiment;

FIG. 7A depicts an exemplary stylus having a force sensor; and

FIG. 7B shows a diagram of the stylus of FIG. 7A.

### DETAILED DESCRIPTION

Reference will now be made in detail to exemplary embodiments of the inventive concepts disclosed herein, which are illustrated in the accompanying drawings. The scope of the disclosure is limited only by the claims; numerous alternatives, modifications, and equivalents are encompassed. For the purpose of clarity, technical material that is known in the technical fields related to the embodiments has not been described in detail to avoid unnecessarily obscuring the description.

Some embodiments include a touchscreen display (e.g., a zero-force touchscreen display, such as a capacitive touchscreen display or a beam interrupt touchscreen display) that includes a touchscreen sensor, a display stack, at least one controller, and a plurality of force sensors. The plurality of force sensors may be implemented under the display stack, above the display stack, within the display stack, may be otherwise positioned in relation to the display stack, or may include a combination thereof. Such embodiments are configured to detect and determine touch location information and touch force information. The touch location information and touch force information may be utilized by a controller, a processor, and/or a computing device for performing various operations. For example, when a user presses a GUI button displayed by the touchscreen display, a processing element (e.g., a controller, a processor, or the like) may determine whether to accept the input as a selection based on whether a touch force associated with the input exceeds an activation force threshold associated with a determined touch location of the input. The activation force threshold may be fixed or variable (e.g., dynamically controllable) based on a location of the touchscreen. That is, an activation force near an edge of the touchscreen display may be less than an activation force near a center of the touchscreen display. Further, a processing element may require a particular minimum force (e.g., 50 gram-force (one gram-force is the force exerted by Earth's gravity at sea level on one gram of mass)) for a button selection and a lesser minimum force (e.g., 5 gram-force) for a gesture. Additionally, the touchscreen display may be calibrated to have an effective uniform activation touch force (or any desired distribution of fixed (e.g., predetermined) or variable (e.g., dynamically adjustable, such as user programmable or process adjustable) activation touch forces) across the entire display surface; such effective uniform activation touch force overcomes a major deficiency with current resistive touchscreens. Some embodiments are configured to filter out environmental vibrations (e.g., vibrations caused by a vehicle such as an aircraft or automobile) from the force sensor data so that environmental vibrations are not misinterpreted as a user's touch force.

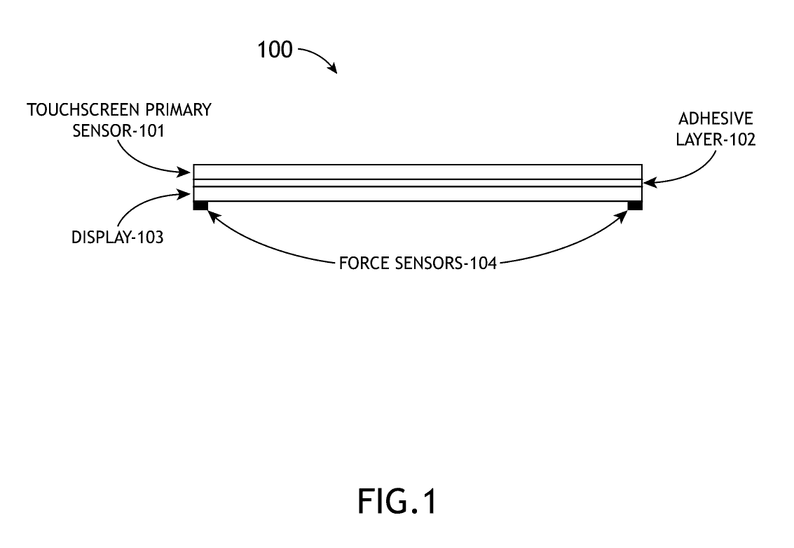

Referring now to FIG. 1, a cross-sectional diagram of a portion of a touchscreen display device 100 of one embodiment is shown. The touchscreen display device 100 may include a touchscreen primary sensor 101, an adhesive layer 102, a display 103, and at least one force sensor 104 (or a plurality of force sensors 104). The touchscreen display device 100 may include one or more other components such as a cover transparent substrate, other substrates (such as plastic or glass substrates), other adhesive layers, light control films, polarizing films, a gap, a diffuser, a backlight, support structure, an electromagnetic interference (EMI) shield, a bezel, a housing, communicative coupling elements (e.g., wires, cables, connectors), connectivity ports, a power supply, a processor, a circuit board (e.g., printed circuit board (PCB)), a controller, memory, storage, an antenna, or the like. Some or all of the components of the touchscreen display device 100 may be communicatively coupled. The touchscreen display device 100 may include or be implemented as a head-down touchscreen display, an integrated touchscreen display system, and/or the like in a vehicle (e.g., an automobile or an aircraft). Additionally, the touchscreen display device 100 may be implemented as any of various touchscreen display devices, such as a touchscreen computing device, a smart phone, a tablet computing device, a touchscreen kiosk, or the like.

The touchscreen display device 100 may be implemented as a capacitive touchscreen display device (such as Projected Capacitive Touch (PCT) touchscreen display device (e.g., a mutual capacitance PCT touchscreen display device, a self-capacitance PCT touchscreen display device)), a resistive touchscreen display device, a beam interrupt touchscreen display device (such as a an infrared grid touchscreen device), an optical touchscreen display device, a touchscreen display device configured to detect piezoelectricity in glass due to a touch, variants thereof, or the like.

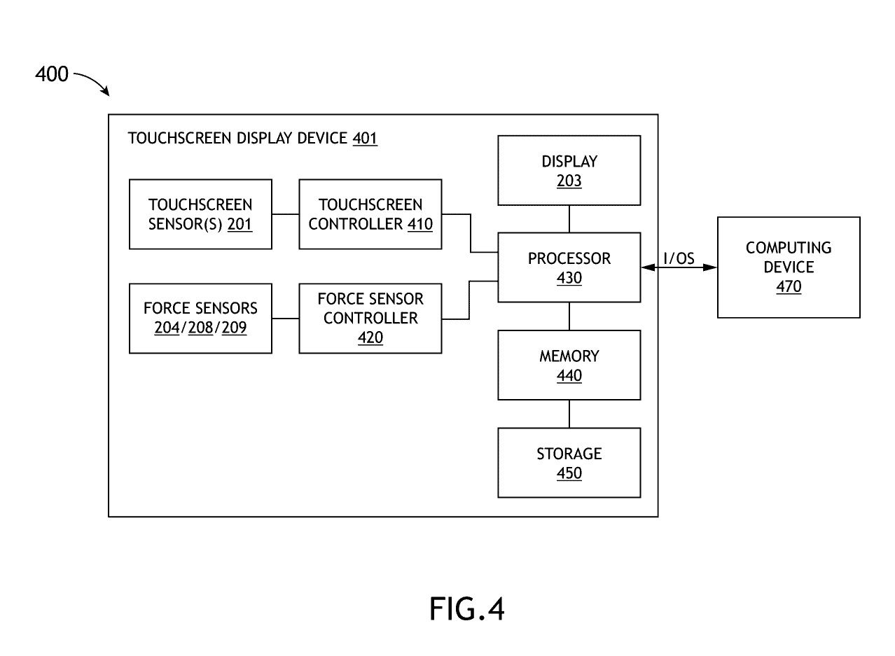

The touchscreen primary sensor 101 may be configured to sense a touch or near touch (such as a finger or apparatus (e.g., a stylus or glove) in proximity to a user-interfaceable surface of the touchscreen display device 100) of the touchscreen display device 100. For example, where the touchscreen display device 100 is a capacitive touchscreen display device, the touchscreen primary sensor 101 may include a transparent conductor layer (such as indium tin oxide (ITO)) deposited on an insulator substrate (such as glass), which results in a measurable change in capacitance when the surface of the touchscreen primary sensor 101 is touched or nearly touched. Further, where the touchscreen display 100 is a beam interrupt touchscreen display device, the touchscreen primary sensor 101 may include an array (e.g., an X-Y grid) of pairs of beam emitters (e.g., light emitting diodes (LEDs)) and sensors (e.g., photodetectors) configured to detect a disruption of a beam or beam pattern during the occurrence of a touch or near touch of a user-interfaceable surface of the touchscreen display device 100. The touchscreen primary sensor 101 is configured to output data (e.g., touch location information as signals or a change in electrical properties) to a controller (e.g., touchscreen controller 410, as shown in FIG. 4), a processor (e.g., processor 430, as shown in FIG. 4), or another computing device (e.g., computing device 470, as shown in FIG. 4).

The adhesive layer 102 may include a transparent adhesive positioned between the display 103 and the touchscreen primary sensor 101. The adhesive layer 102 may bond the display 103 to a substrate of the touchscreen primary sensor 101. In some embodiments, the adhesive layer 102 may be omitted. Further, the touchscreen display device 100 may include various other elements or layers positioned between or outside of the display 103 and the touchscreen primary sensor 101; such other elements may include polarizers, waveguides, transparent or non-transparent substrates (e.g., transparent or non-transparent glass or plastic substrates), other components disclosed throughout, or the like. Additionally, while FIG. 1 shows the display 103 and the touchscreen primary sensor 101 as being separate elements, in other embodiments the touchscreen primary sensor 101 and the display 103 may be implemented as a single element or in a single substrate; for example, a display element may be implemented in a substrate that also includes piezoelectric touchscreen sensors within the substrate. Some embodiments may include other adhesive layers, such as an adhesive layer bonding a bottom surface of the display 103 to a substrate (such as a transparent glass or plastic substrate under a transmissive display element or a transparent or non-transparent substrate under an emissive display element).

The display 103 may be implemented as display element configured to emit or impart an image for presentation to user. The display 103 may be implemented as a transmissive display element, an emissive display element, as well as other types of display elements. For example, where the display is implemented as a transmissive display element, the display 103 may be implemented as a liquid crystal display (LCD) element. For example, where the display is implemented as an emissive display element, the display 103 may be implemented as an organic light-emitting diode (OLED) display element, such as active-matrix OLEDs (AMOLEDs), passive-matrix OLEDs (PMOLEDs), light-emitting electrochemical cells (LECs), or the like.

Each of the force sensors 104 is configured to detect an amount of force (e.g., compressive force) acting on (e.g., applied by a user when the user is touching a user-interfaceable surface of the touchscreen display device 100) on the force sensor 104. In some embodiments, the force sensors 104 are implemented as conductive polymer force sensors, piezoelectric force sensors, other suitable force sensors, or a combination thereof. Each force sensor 104 is configured to output data (e.g., touch force information as signals or a change in electrical properties) to a controller (e.g., force sensor controller 420, as shown in FIG. 4), a processor (e.g., processor 430, as shown in FIG. 4), or another computing device (e.g., computing device 470, as shown in FIG. 4). In some embodiments, the force sensors 104 are opaque, while in other embodiments the force sensors 104 are transparent or a combination of opaque force sensors and transparent force sensors. As shown in the embodiment depicted in FIG. 1, the force sensors are positioned below the display 103 and along the edges of the display 103. In other embodiments, the force sensors 104 may be implemented in any of various suitable locations and/or configurations. For example, the force sensors 104 may be positioned below, above, or within the display 103. Additionally, for example, a single force sensor 104 may be implemented as a ring (e.g., rectangular ring) located below or above the display 103 and in proximity to the edges of the display 103. Also, for example, the force sensors 104 may be implemented as strips, where each strip is located along an edge of the display 103. Further, for example, the force sensors 104 may be arranged in an array (e.g., rows, columns, a grid of rows and columns, concentric circles, or the like) of force sensors 104 across the bottom of the display 103.

In some embodiments, the touchscreen primary sensor 101 and the force sensors 104 may be at the same location or implemented in a same layer or substrate. Additionally, in some embodiments, the touchscreen primary sensor 101 may be omitted, and a touch location may be determined (e.g., inferred) by comparing (e.g., by a processor or controller) different forces detected by two or more (e.g., three or more) of the force sensors 104, which may be positioned at different locations with respect to a user-interfaceable surface of the touchscreen display device 100.

Touch location information (e.g., from the touchscreen primary sensor 101) and touch force information (e.g., from the force sensors 104) may be utilized by a controller, a processor, and/or a computing device for performing various operations, which for example are described in more detail with respect to FIG. 4, as well as described throughout.

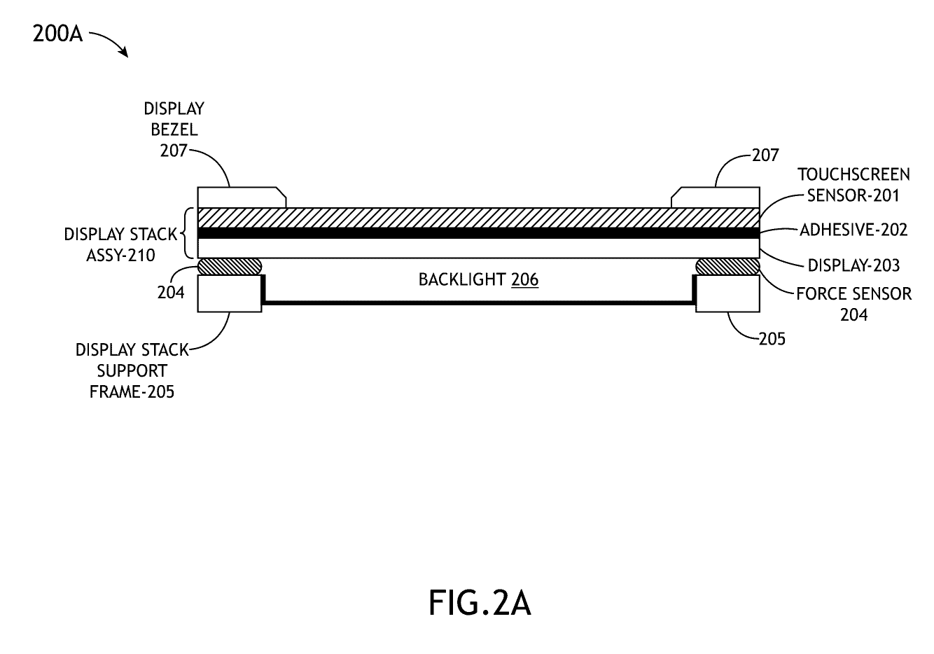

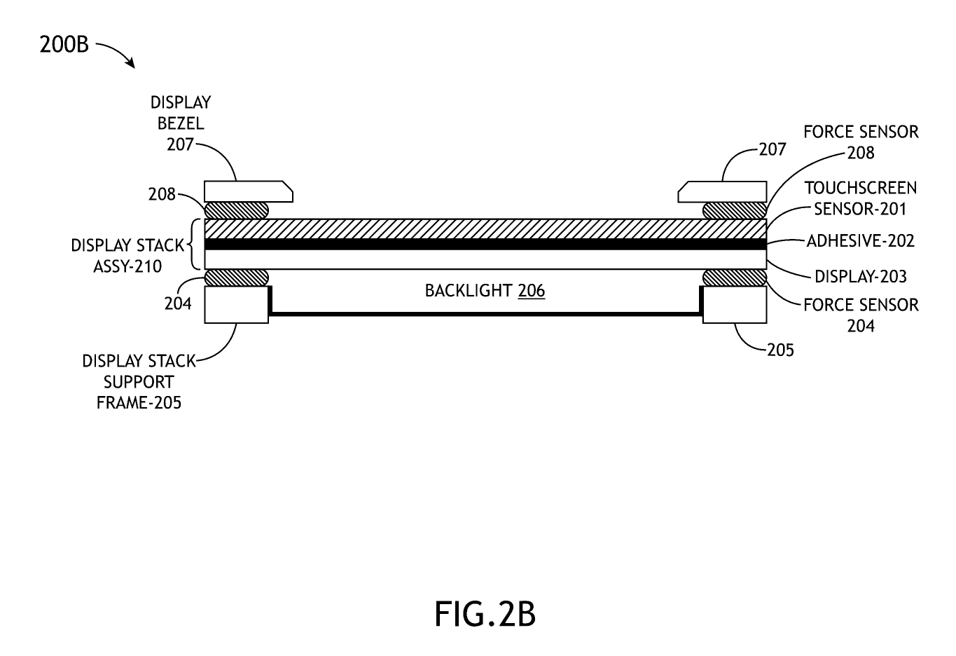

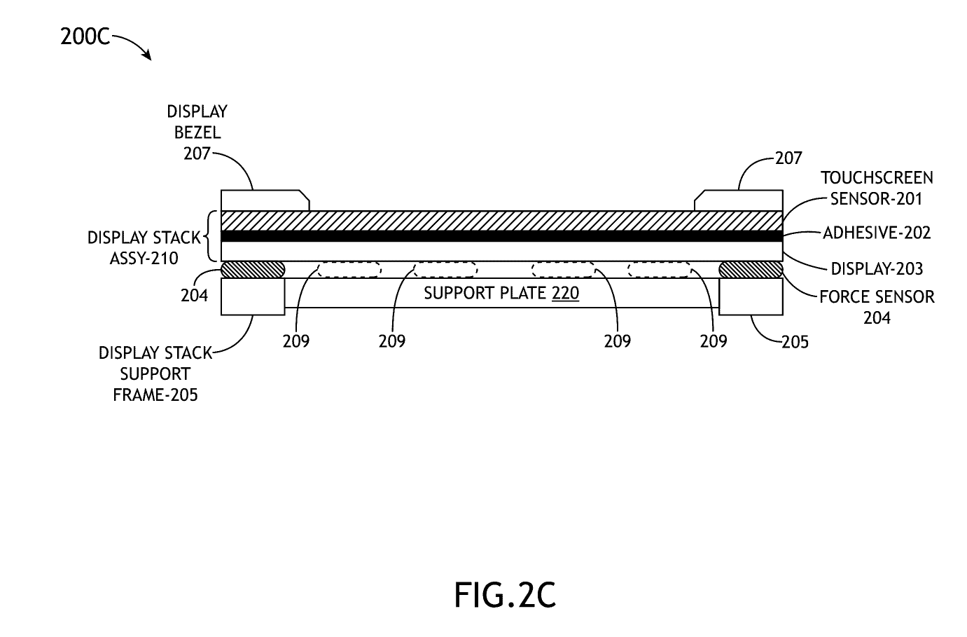

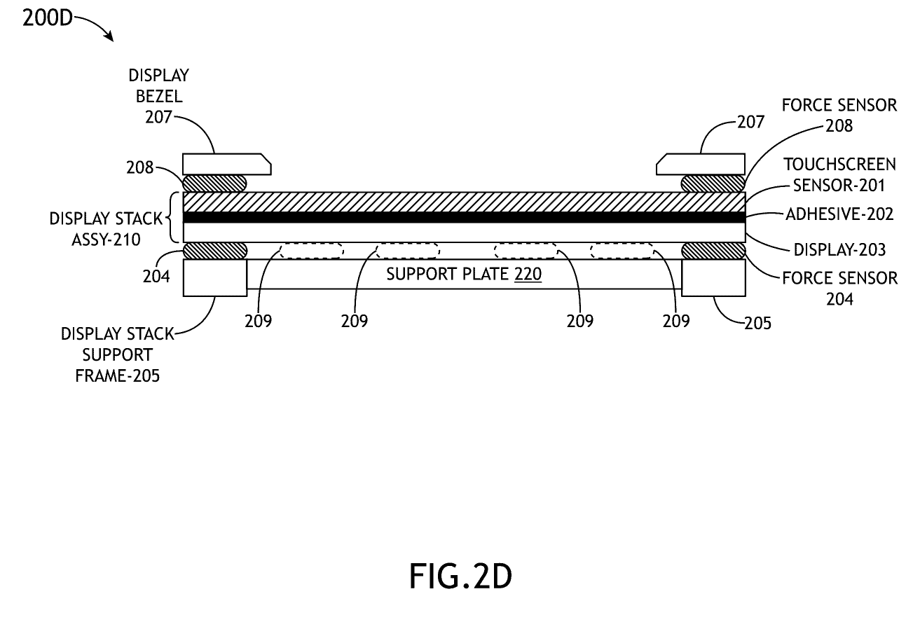

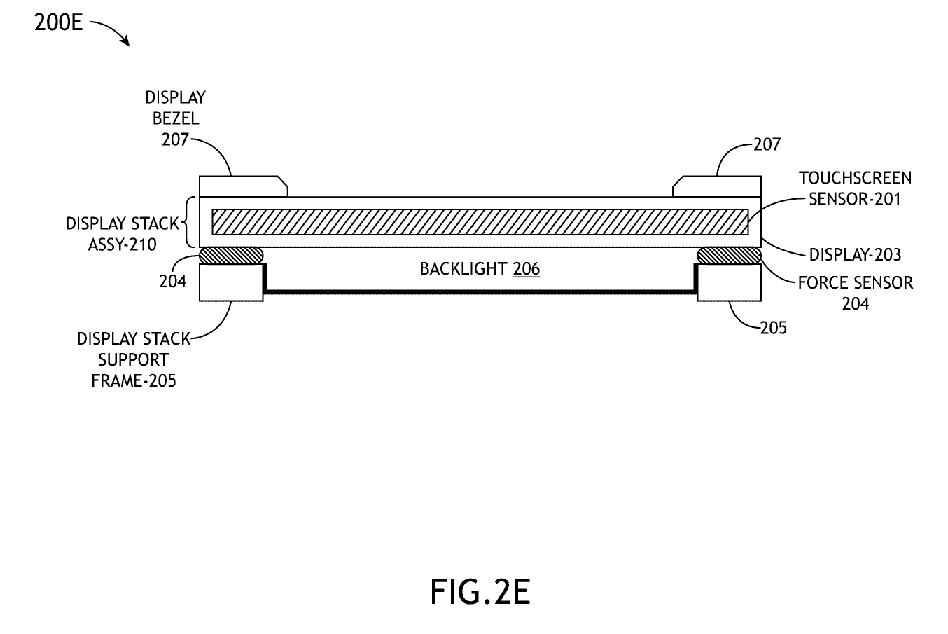

Referring now to FIG. 2A, a cross-sectional diagram of portion of a touchscreen display device 200A of one embodiment is shown. The touchscreen display device 200A may include a display bezel 207, a display stack assembly 210, at least one force sensor 204 (e.g., a plurality of force sensors 204), a support structure (e.g., a support frame, such as a display stack support frame 205), and a backlight 206. The touchscreen display device 200A may include one or more other components, such as a cover transparent substrate, light control films, polarizing films, a gap, a diffuser, a housing, communicative coupling elements (e.g., wires, cables, connectors, etc.), connectivity ports, a power supply, a processor, a circuit board (e.g., printed circuit board (PCB)), a controller, memory, storage, an antenna, or the like. Some or all of the components of the touchscreen display device 200A may be communicatively coupled. The touchscreen display device 200A may include or be implemented as a head-down touchscreen display, an integrated touchscreen display system, and/or the like in a vehicle (e.g., an automobile or an aircraft). Additionally, the touchscreen display device 200A may be implemented as any of various touchscreen display devices, such as a touchscreen computing device, a smart phone, a tablet computing device, a touchscreen kiosk, or the like.

The touchscreen display device 200A may be implemented as a capacitive touchscreen display device (such as Projected Capacitive Touch (PCT) touchscreen display (e.g., a mutual capacitance PCT touchscreen display device, a self-capacitance PCT touchscreen display device)), a resistive touchscreen display device, a beam interrupt touchscreen display device (such as a an infrared grid touchscreen), an optical touchscreen display device, a touchscreen display device configured to detect piezoelectricity in glass due to a touch, variants thereof, or the like.

With respect to the embodiment depicted in FIG. 2A, the bezel 207 is positioned above the display stack assembly 210. The display stack assembly 210 is positioned between the bezel 207, on the top side, and the force sensors 204 and the backlight 206, on the bottom side. The force sensors 204 are positioned between the display stack assembly 210 and the display stack support frame 205, and the force sensors 204 are positioned under the edges of the display stack assembly 210. The backlight 206 is positioned under the display stack assembly 210 and between the display stack support frame 205. While FIG. 2A depicts one embodiment having an exemplary arrangement of components of the touchscreen display device 200A, other embodiments may include any suitable arrangements of the same or other components.

Referring still to FIG. 2A, the display stack assembly 210 may include a touchscreen sensor 201, an adhesive layer 202, and a display 203 as similarly described with respect to FIG. 1. The display stack assembly 210 may include other components, such as a rigid or substantially rigid substrate.

The touchscreen sensor 201 may be configured to sense a touch or near touch (such as a finger or apparatus (e.g., a stylus or glove) in proximity to a user-interfaceable surface of the touchscreen display device 200A) of the touchscreen display device 200A. For example, where the touchscreen display device 200A is a capacitive touchscreen display device, the touchscreen sensor 201 may include a transparent conductor layer (such as indium tin oxide (ITO)) deposited on an insulator substrate (such as glass), which results in a measurable change in capacitance when the surface of the touchscreen sensor 201 is touched or nearly touched. Further, for example, where the touchscreen display device 200A is a beam interrupt touchscreen display device, the touchscreen sensor 201 may include an array (e.g., an X-Y grid) of pairs of beam emitters (e.g., light emitting diodes (LEDs)) and sensors (e.g., photodetectors) configured to detect a disruption of a beam or beam pattern during the occurrence of a touch or near touch of the touchscreen display device 200A. The touchscreen sensor 201 is configured to output data (e.g., touch location information as signals or a change in electrical properties) to a controller (e.g., touchscreen controller 410, as shown in FIG. 4), a processor (e.g., processor 430, as shown in FIG. 4), or another computing device (e.g., computing device 470, as shown in FIG. 4).

The adhesive layer 202 may include a transparent adhesive positioned between the display 203 and the touchscreen sensor 201. The adhesive layer 202 may bond the display 203 to a substrate of the touchscreen sensor 201. In some embodiments, the adhesive layer 202 may be omitted. In some embodiments, another adhesive layer may bond a bottom surface of the display 203 to a rigid or substantially rigid substrate below the display 203.

As shown in FIG. 2A, the display 203 may be implemented as display element configured to impart an image for presentation to user. As shown in FIG. 2A, the display 203 is implemented as a transmissive display element. For example, the transmissive display element may be implemented as a liquid crystal display (LCD) element.

Referring to FIG. 2A, each of the force sensors 204 is configured to detect an amount of force (e.g., compressive force) acting on (e.g., applied by a user when the user is touching a user-interfaceable surface of the touchscreen display device 200A) on the force sensor 204. In some embodiments, the force sensors 204 are implemented as conductive polymer force sensors, piezoelectric force sensors, other suitable force sensors, or a combination thereof. Each force sensor 204 is configured to output data (e.g., touch force information as signals or a change in electrical properties) to a controller (e.g., force sensor controller 420, as shown in FIG. 4), a processor (e.g., processor 430, as shown in FIG. 4), or another computing device (e.g., computing device 470, as shown in FIG. 4). In some embodiments, the force sensors 204 are opaque, while in other embodiments the force sensors 204 are transparent or a combination of opaque force sensors and transparent force sensors. As shown in FIG. 2A, the force sensors 204 are positioned below the display 203 and along the edges of the display 203. In other embodiments, the force sensors 204 may be implemented in any of various suitable locations and/or configurations. For example, the force sensors 204 may be positioned below, above, or within the display stack assembly 210. Additionally, for example, a single force sensor 204 may be implemented as a ring (e.g., rectangular ring) located below or above the display 203 and in proximity to the edges of the display 203. Also, for example, the force sensors 204 may be implemented as strips, where each strip is located along an edge of the display 203. Further, for example, the force sensors 204 may be arranged in an array (e.g., rows, columns, a grid of rows and columns, arranged in a pattern of concentric circles, or the like) of transparent force sensors arranged across (e.g., in a plane above, below, or within the display stack assembly 210) the display 203 (e.g. a transmissive display).

Referring still to FIG. 2A, touch location information (e.g., from the touchscreen sensor 201) and touch force information (e.g., from the force sensors 204) may be utilized by a controller, a processor, and/or a computing device for performing various operations, which for example are described in more detail with respect to FIG. 4, as well as described throughout.

Referring now to FIG. 2B, a cross-sectional diagram of portion of a touchscreen display device 200B of one embodiment is shown. The touchscreen display device 200B may be implemented and may function similarly to the touchscreen display device 200A shown in FIG. 2A, except that the touchscreen display device 200B may further include at least one force sensor 208 (e.g., a plurality of force sensors 208) positioned above the display stack assembly 210.

With respect to the embodiment depicted in FIG. 2B, the bezel 207 is positioned above the force sensors 208 and the display stack assembly 210. The force sensors 208 are positioned between the bezel 207 and the display stack assembly 210 along the edges of the display stack assembly 210. The display stack assembly 210 is positioned between the bezel 207 and the force sensors 208, on the top side, and the force sensors 204 and the backlight 206, on the bottom side. The force sensors 204 are positioned between the display stack assembly 210 and the display stack support frame 205, and the force sensors 204 are positioned under the edges of the display stack assembly 210. The backlight 206 is positioned under the display stack assembly 210 and between the display stack support frame 205. While FIG. 2B depicts one embodiment having an exemplary arrangement of components of the touchscreen display device 200B, other embodiments may include any suitable arrangements of the same or other components.

Referring to FIG. 2B, each of the force sensors 208 is configured to detect an amount of force (e.g., tensile force) acting on (e.g., applied by a user when the user is touching the touchscreen display device 200B) on the force sensor 208. In some embodiments, the force sensors 208 are implemented as conductive polymer force sensors, piezoelectric force sensors, other suitable force sensors, or a combination thereof. Each force sensor 208 is configured to output data (e.g., touch force information as signals or a change in electrical properties) to a controller (e.g., force sensor controller 420, as shown in FIG. 4), a processor (e.g., processor 430, as shown in FIG. 4), or another computing device (e.g., computing device 470, as shown in FIG. 4). In some embodiments, the force sensors 208 are opaque, while in other embodiments the force sensors 208 are transparent or a combination of opaque force sensors and transparent force sensors. As shown in the embodiment depicted in FIG. 2B, the force sensors 208 are positioned between the bezel 207 and the edges of the display stack assembly 210. In other embodiments, the force sensors 208 may be implemented in any of various suitable locations and/or configurations. For example, the force sensors 208 may be positioned within a portion of the display stack assembly 210. Additionally, for example, a single force sensor 208 may be implemented as a ring (e.g., rectangular ring) located between the display stack assembly 210 and the bezel 207. Also, for example, the force sensors 208 may be implemented as strips, where each strip is located along an edge of the display stack assembly 210. While the embodiment depicted in FIG. 2B includes the force sensors 204, 208, in other embodiments a touchscreen display device may optionally include only one or some of the force sensors 204, 208 or may optionally include other force sensors.

Referring still to FIG. 2B, touch location information (e.g., from the touchscreen sensor 201) and touch force information (e.g., from the force sensors 204 and/or 208) may be utilized by a controller, a processor, and/or a computing device for performing various operations, which for example are described in more detail with respect to FIG. 4, as well as described throughout.

Referring now to FIG. 2C, a cross-sectional diagram of a portion of a touchscreen display device 200C of one embodiment is shown. The touchscreen display device 200C may include a display bezel 207, a display stack assembly 210, at least one force sensor 204 (e.g., a plurality of force sensors 204), at least one force sensor 209 (e.g., a plurality of force sensors 209), a support structure (e.g., a support frame, such as a display stack support frame 205), and a support plate 220. The touchscreen display device 200C may include one or more other components, such as a cover transparent substrate, light control films, polarizing films, a gap, a diffuser, a housing, communicative coupling elements (e.g., wires, cables, connectors, etc.), connectivity ports, a power supply, a processor, a circuit board (e.g., printed circuit board (PCB)), a backlight, a controller, memory, storage, an antenna, or the like. Some or all of the components of the touchscreen display device 200C may be communicatively coupled. The touchscreen display device 200C may include or be implemented as a head-down touchscreen display, an integrated touchscreen display system, and/or the like in a vehicle (e.g., an automobile or an aircraft). Additionally, the touchscreen display device 200C may be implemented as any of various touchscreen display devices, such as a touchscreen computing device, a smart phone, a tablet computing device, a touchscreen kiosk, or the like.

The touchscreen display device 200C may be implemented as a capacitive touchscreen display device (such as Projected Capacitive Touch (PCT) touchscreen display device (e.g., a mutual capacitance PCT touchscreen display device, a self-capacitance PCT touchscreen display device, etc.)), a resistive touchscreen display device, a beam interrupt touchscreen display device (such as a an infrared grid touchscreen), an optical touchscreen display device, a touchscreen display device configured to detect piezoelectricity in glass due to a touch, variants thereof, or the like.

With respect to the embodiment depicted in FIG. 2C, the bezel 207 is positioned above the display stack assembly 210. The display stack assembly 210 is positioned between the bezel 207, on the top side, and the force sensors 204, 209 on the bottom side. The force sensors 204 are positioned between the display stack assembly 210 and the display stack support frame 205, and the force sensors 204 are positioned under the edges of the display stack assembly 210. The force sensors 209 are positioned between the display stack assembly 210 and the support plate 220, and the force sensors 209 are generally positioned under the viewable portion of the display 203. The support plate 220 is positioned under the force sensors 209 and between the display stack support frame 205. While FIG. 2C depicts one embodiment having an exemplary arrangement of components of the touchscreen display device 200C, other embodiments may include any suitable arrangements of the same or other components.

Referring to FIG. 2C, the display stack assembly 210 may include a touchscreen sensor 201, an adhesive layer 202, and a display 203 as similarly described with respect to FIGS. 1-2B.

The touchscreen sensor 201 may be configured to sense a touch or near touch (such as a finger or apparatus (e.g., a stylus or glove) in proximity to a user-interfaceable surface of the touchscreen display device 200C) of the touchscreen display device 200C). For example, where the touchscreen display device 200C is a capacitive touchscreen display device, the touchscreen sensor 201 may include a transparent conductor layer (such as indium tin oxide (ITO)) deposited on an insulator substrate (such as glass), which results in a measurable change in capacitance when the surface of the touchscreen sensor 201 is touched or nearly touched. Further, for example, where the touchscreen display device 200C is a beam interrupt touchscreen display device, the touchscreen sensor 201 may include an array (e.g., an X-Y grid) of pairs of beam emitters (e.g., light emitting diodes (LEDs)) and sensors (e.g., photodetectors) configured to detect a disruption of a beam or beam pattern during the occurrence of a touch or near touch of a user-interfaceable surface of the touchscreen display device 200C. The touchscreen sensor 201 is configured to output data (e.g., touch location information as signals or a change in electrical properties) to a controller (e.g., touchscreen controller 410, as shown in FIG. 4), a processor (e.g., processor 430, as shown in FIG. 4), or another computing device (e.g., computing device 470, as shown in FIG. 4).

The adhesive layer 202 may include a transparent adhesive positioned between the display 203 and the touchscreen sensor 201. The adhesive layer 202 may bond the display 203 to a substrate of the touchscreen sensor 201. In some embodiments, the adhesive layer 202 may be omitted.

As shown in FIG. 2C, the display 203 may be implemented as display element configured to emit light as an image for presentation to user. As shown in FIG. 2C, the display 203 is implemented as an emissive display element. For example, the display 203 may be implemented as an organic light-emitting diode (OLED) display element, such as active-matrix OLEDs (AMOLEDs), passive-matrix OLEDs (PMOLEDs), light-emitting electrochemical cells (LECs), or the like.

Referring to FIG. 2C, each of the force sensors 204 is configured to detect an amount of force (e.g., compressive force) acting on (e.g., applied by a user when the user is touching a user-interfaceable surface of the touchscreen display device 200C) on the force sensor 204. In some embodiments, the force sensors 204 are implemented as conductive polymer force sensors, piezoelectric force sensors, other suitable force sensors, or a combination thereof. Each force sensor 204 is configured to output data (e.g., touch force information as signals or a change in electrical properties) to a controller (e.g., force sensor controller 420, as shown in FIG. 4), a processor (e.g., processor 430, as shown in FIG. 4), or another computing device (e.g., computing device 470, as shown in FIG. 4). In some embodiments, the force sensors 204 are opaque, while in other embodiments the force sensors 204 are transparent or a combination of opaque force sensors and transparent force sensors. As shown in the embodiments depicted in FIG. 2C, the force sensors 204 are positioned below the display 203 and along the edges of the display 203. In other embodiments, the force sensors 204 may be implemented in any of various suitable locations and/or configurations. For example, the force sensors 204 may be positioned below, above, or within the display stack assembly 210. Additionally, for example, a single force sensor 204 may be implemented as a ring (e.g., rectangular ring) located below or above the display 203 and in proximity to the edges of the display 203. Also, for example, the force sensors 204 may be implemented as strips, where each strip is located along an edge of the display 203.

Referring to FIG. 2C, each of the force sensors 209 is configured to detect an amount of force (e.g., compressive force) acting on (e.g., applied by a user when the user is touching a user-interfaceable surface of the touchscreen display device 200C) on the force sensor 209. In some embodiments, the force sensors 209 are implemented as conductive polymer force sensors, piezoelectric force sensors, other suitable force sensors, or a combination thereof. Each force sensor 209 is configured to output data (e.g., touch force information as signals or a change in electrical properties) to a controller (e.g., force sensor controller 420, as shown in FIG. 4), a processor (e.g., processor 430, as shown in FIG. 4), or another computing device (e.g., computing device 470, as shown in FIG. 4). In some embodiments, the force sensors 209 are opaque, while in other embodiments the force sensors 209 are transparent or a combination of opaque force sensors and transparent force sensors. As shown in the embodiments depicted in FIG. 2C, the force sensors 209 are positioned below the display 203 generally under the viewable portion of the display 203. In other embodiments, the force sensors 209 may be implemented in any of various suitable locations and/or configurations. For example, the force sensors 209 may be positioned below, above, or within the display stack assembly 210. Additionally, for example, a single force sensor 209 may be implemented as a ring (e.g., rectangular ring) located below the viewable portion of the display 203. Also, for example, the force sensors 209 may be implemented as strips, where each strip is located below the viewable portion of the display 203. Additionally, for example, the force sensors 209 may be arranged in an array (e.g., rows, columns, a grid of rows and columns, arranged in a pattern of concentric circles, or the like) of opaque or non-opaque force sensors arranged beneath the viewable portion of the display 203 (e.g. an emissive display). Further, for example, the force sensors 209 may be arranged in an array (e.g., rows, columns, a grid of rows and columns, arranged in a pattern of concentric circles, or the like) of transparent force sensors arranged across (e.g., in a plane above, below, or within the display stack assembly 210) the viewable portion of the display 203 (e.g. an emissive display). While the embodiment depicted in FIG. 2C includes the force sensors 209, in some embodiments the force sensors 209 may be omitted.

Referring still to FIG. 2C, touch location information (e.g., from the touchscreen sensor 201) and touch force information (e.g., from the force sensors 204 and/or 209) may be utilized by a controller, a processor, and/or a computing device for performing various operations, which for example are described in more detail with respect to FIG. 4, as well as described throughout.

Referring now to FIG. 2D, a cross-sectional diagram of portion of a touchscreen display device 200D of one embodiment is shown. The touchscreen display device 200D may be implemented and may function similarly to the touchscreen display device 200C shown in FIG. 2C, except that the touchscreen display device 200D may further include at least one force sensor 208 (e.g., a plurality of force sensors 208) positioned above the display stack assembly 210.

With respect to the embodiment depicted in FIG. 2D, the bezel 207 is positioned above the force sensors 208 and the display stack assembly 210. The force sensors 208 are positioned between the bezel 207 and the display stack assembly 210 along the edges of the display stack assembly 210. The display stack assembly 210 is positioned between the bezel 207 and the force sensors 208, on the top side, and the force sensors 204, 209 on the bottom side. The force sensors 204 are positioned between the display stack assembly 210 and the display stack support frame 205, and the force sensors 204 are positioned under the edges of the display stack assembly 210. The force sensors 209 are positioned between the display stack assembly 210 and the support plate 220, and the force sensors 209 are generally positioned under the viewable portion of the display 203. The support plate 220 is positioned under the force sensors 209 and between the display stack support frame 205. While FIG. 2D depicts one embodiment having an exemplary arrangement of components of the touchscreen display device 200D, other embodiments may include any suitable arrangements of the same or other components.

Referring to FIG. 2D, each of the force sensors 208 is configured to detect an amount of force (e.g., tensile force) acting on (e.g., applied by a user when the user is touching the touchscreen display device 200D) on the force sensor 208. In some embodiments, the force sensors 208 are implemented as conductive polymer force sensors, piezoelectric force sensors, other suitable force sensors, or a combination thereof. Each force sensor 208 is configured to output data (e.g., touch force information as signals or a change in electrical properties) to a controller (e.g., force sensor controller 420, as shown in FIG. 4), a processor (e.g., processor 430, as shown in FIG. 4), or another computing device (e.g., computing device 470, as shown in FIG. 4). In some embodiments, the force sensors 208 are opaque, while in other embodiments the force sensors 208 are transparent or a combination of opaque force sensors and transparent force sensors. As shown in the embodiment depicted in FIG. 2D, the force sensors 208 are positioned between the bezel 207 and the edges of the display stack assembly 210. In other embodiments, the force sensors 208 may be implemented in any of various suitable locations and/or configurations. For example, the force sensors 208 may be positioned within a portion of the display stack assembly 210. Additionally, for example, a single force sensor 208 may be implemented as a ring (e.g., rectangular ring) located between the display stack assembly 210 and the bezel 207. Also, for example, the force sensors 208 may be implemented as strips, where each strip is located along an edge of the display stack assembly 210. While the embodiment depicted in FIG. 2D includes the force sensors 204, 208, 209, in other embodiments a touchscreen display device may optionally include only one or some of the force sensors 204, 208, 209 or may optionally include other force sensors.

Referring still to FIG. 2D, touch location information (e.g., from the touchscreen sensor 201) and touch force information (e.g., from the force sensors 204, 208, and/or 209) may be utilized by a controller, a processor, and/or a computing device for performing various operations, which for example are described in more detail with respect to FIG. 4, as well as described throughout.

Referring now to FIG. 2E, a cross-sectional diagram of portion of a touchscreen display device 200E of one embodiment is shown. The touchscreen display device 200E may be implemented and may function similarly to the touchscreen display device 200A shown in FIG. 2A, except that the touchscreen sensor 201 may be implemented in the display 203. Where the display 203 is implemented as a transmissive display element, as shown in FIG. 2E, the display 203 may be implemented as an in-cell or on-cell LCD display element such that the LCD display element and the touchscreen sensor 201 are implemented in a single layer.

Further, in some embodiments, the touchscreen sensor 201 may be included in a display 203 that is implemented as an emissive display element (such as shown in and described with respect to FIGS. 2C-D).

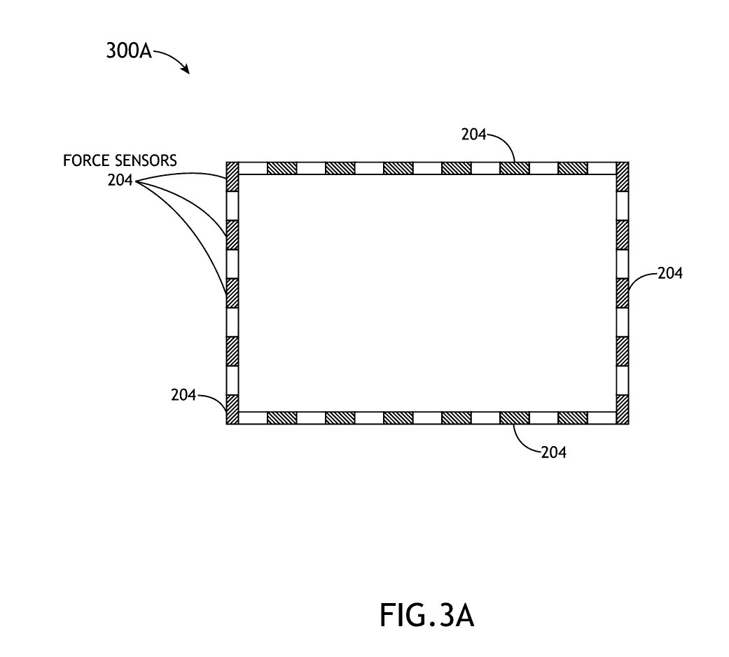

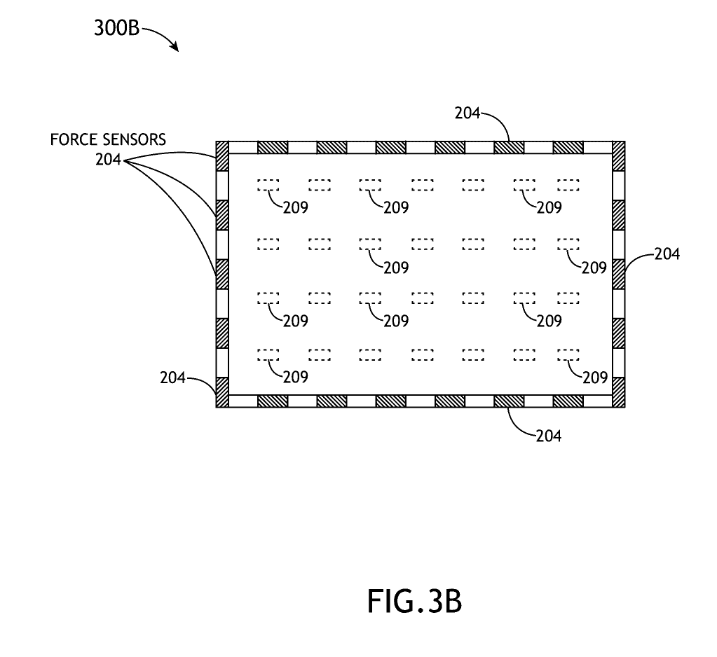

Referring now to FIG. 3A, a diagram 300A of a top, cross-section of a portion of a touchscreen display device (e.g., 200A, 200B, 200C, 200D, 200E) of one embodiment is shown. FIG. 3A shows an exemplary arrangement of the force sensors 204 along the edges of the touchscreen display device (e.g., 200A, 200B, 200C, 200D, 200E). While an exemplary arrangement of the force sensors 204 is depicted in FIG. 3A, in other embodiments at least one force sensor 204 may be implemented in any of various suitable arrangements or suitable implementations.

Referring now to FIG. 3B, a diagram 300B of a top, cross-section of a portion of a touchscreen display device (e.g., 200C or 200D) of one embodiment is shown. FIG. 3B shows an exemplary arrangement of the force sensors 204 along the edges of the touchscreen display device (e.g., 200C or 200D). FIG. 3B also shows an exemplary arrangement of the force sensors 209 arranged in a grid pattern of rows and columns with respect to a viewable portion of the touchscreen display device (e.g., 200C or 200D). While an exemplary arrangement of the force sensors 204 is depicted in FIG. 3B, in other embodiments at least one force sensor 204 may be implemented in any of various suitable arrangements or suitable implementations. While an exemplary arrangement of the force sensors 209 is depicted in FIG. 3B, in other embodiments at least one force sensor 209 may be implemented in any of various suitable arrangements or suitable implementations. Additionally, while the exemplary depiction in FIG. 3B shows the force sensors 209 and the force sensors 204 as having different sizes, in other embodiments, the force sensors 204 and 209 may have the same size, as well as the same or different properties. Further, while the exemplary depiction in FIG. 3B shows the arrangement of force sensors 209 in a grid pattern that does not align with the spacing or alignment of the arrangement of the force sensors 204, in other embodiments, the force sensors 204 and the force sensors 209 may share (e.g., align in) a common arrangement scheme (e.g., a common grid pattern).

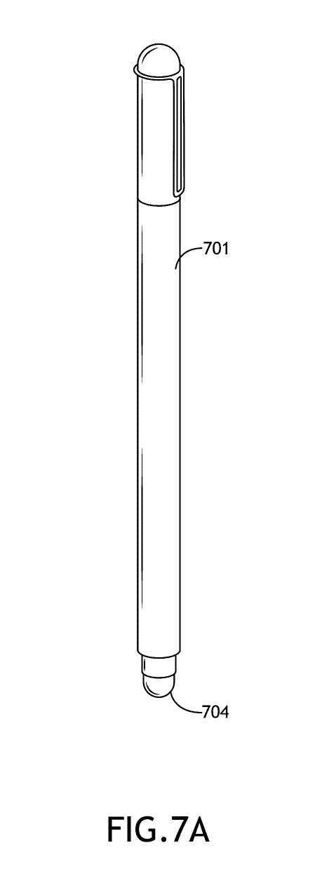

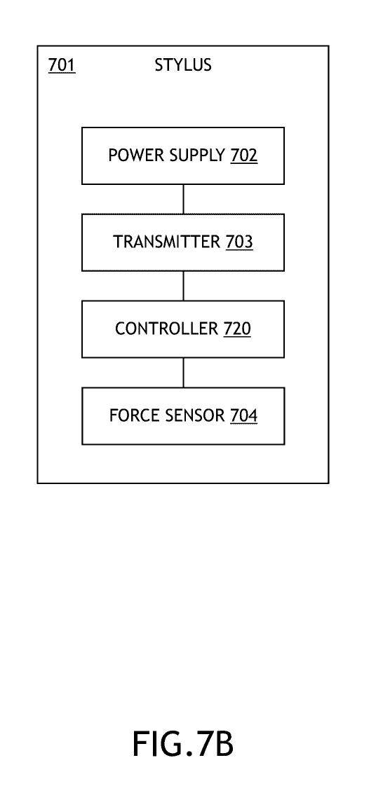

Referring now to FIG. 4, a diagram of a system 400 of one embedment is depicted. As depicted, the system 400 includes at least one touchscreen display device 401 and at least one computing device 470; however, in other embodiments, the computing device 470 may be omitted or the system 400 may include other devices (e.g., a plurality of computing devices 470, a stylus 701 (as shown in FIGS. 7A-B), or the like). The touchscreen display device 401 and the computing device 470 may be communicatively coupled, such as by a cabled connection, a wireless connection, a connection via one or more networks (e.g., internet, an intranet, a local area network, a wireless area network, a mobile network, and/or the like), a connection via one or more satellites, a connection via one or more radio frequency receivers and/or transmitters, some combination thereof, or the like. For example, the touchscreen display device 401 may be implemented as a touchscreen display device onboard a vehicle (e.g., an aircraft or automobile), and the computing device 470 may be implemented as an off-board computing device remotely connected to the touchscreen display device onboard the vehicle. Additionally, for example, the touchscreen display device 401 and the computing device 470 may be implemented onboard a vehicle (e.g., an aircraft or automobile), and the computing device 470 and the touchscreen display device 401 may be connected via a cable such that they can exchange data, such as inputs and outputs (I/Os). Additionally, the touchscreen display device 401 may be communicatively coupled with other devices, such as a stylus 701 (as shown in FIGS. 7A-B) or other user device (such as a glove).

The touchscreen display device 401 may include or be implemented as a head-down touchscreen display, an integrated touchscreen display system, and/or the like in a vehicle (e.g., an automobile or an aircraft). Additionally, the touchscreen display device 401 may be implemented as any of various touchscreen display devices, such as a touchscreen computing device, a smart phone, a tablet computing device, a touchscreen kiosk, or the like. The touchscreen display device 401 may be implemented as a zero-force touchscreen display device, such as a capacitive touchscreen display device or a beam interrupt touchscreen display device. In embodiments where the touchscreen display device 401 is implemented as a zero-force touchscreen display device, the touchscreen sensor 201 may not (e.g., does not) provide the touchscreen controller 410 with any touch force information.

The touchscreen display device 401 may include any of the components and configurations as described and illustrated with respect to FIGS. 1-3B.

As shown in FIG. 4, the touchscreen display device 401 includes at least one touchscreen sensor 201 (e.g., as shown and described with respect to FIGS. 2A-E), at least one force sensor (e.g., at least one force sensor 204, at least one force sensor 208, and/or at least one force sensor 209, as shown and described with respect to FIGS. 2A-3B), a display 203 (e.g., as shown and described with respect to FIGS. 2A-E), at least one processing element (e.g., touchscreen controller 410, force sensor controller 420, and processor 430), memory 440, and storage 450, as well as other components commonly included in a touchscreen display device. Some or all of the touchscreen sensor 201, the at least one force sensor (e.g., 204, 208, and/or 209), the display 203, the touchscreen controller 410, the force sensor controller 420, the processor 430, the memory 440, and the storage 450, as well as other components may be communicatively coupled.

The at least one processing element of the touchscreen display device 401 may include at least one touchscreen controller 410, at least one force sensor controller 420, and at least one processor 430. While FIG. 4 depicts an embodiment where the touchscreen controller 410, the force sensor controller 420, and the processor 430 are implemented as separate processing elements, the functionality of the touchscreen controller 410, the force sensor controller 420, and the processor 430 may be implemented as a single processing element (e.g., a single integrated circuit chip configured to perform the functionality of the touchscreen controller 410, the force sensor controller 420, and the processor 430) or as any number of separate processing elements (e.g., processing elements implemented on multiple integrated circuit chips, processing elements implemented as circuits within a single integrated circuit chip, or the like) implemented within a single device or on multiple devices (e.g., touchscreen display device 401 and computing device 470). For example, the touchscreen controller 410 and the force sensor controller 420 may be implemented as circuits (e.g., digital and/or analog circuits) which are integrated in the processor 420. Further, for example, the touchscreen controller 410 and the force controller 420 may be implemented in the touchscreen display device 401, and the processor 430 may be implemented in another device (e.g., computing device 470). Additionally, the at least one processing element may be configured to run various software applications, firmware, or computer code stored in a non-transitory computer-readable medium (e.g., memory 440 and/or storage 450, memory and/or storage of computing device 470, or the like) and configured to execute various instructions, functionality, and/or operations as disclosed throughout.

As shown in FIG. 4, when a user touches or nearly touches a user-interfaceable surface of the touchscreen display device 401, the touchscreen controller 410 is configured to receive signals or changes in electrical properties from the touchscreen sensor 201 and output touch location data (e.g., data of touch location information) to the processor 430. The touch location data includes information associated with a detected location of a user's touch relative to the user-interfaceable surface. For example, the touchscreen location data may include horizontal and vertical axis coordinates (e.g., X-axis and Y-axis coordinates) of a point or region associated with a detected touch or near touch. Further, for example, when a user performs a gesture, the touchscreen controller may output a stream of changing (e.g., dynamically changing over time) touchscreen location data to the processor 430. In some embodiments, the touch location data obtained from the touch sensor 201 does not include any touch force information.

As shown in FIG. 4, when a user touches and exerts a force (e.g. a compressive force) on the user-interfaceable surface of the touchscreen display device 401, the force sensor controller 410 is configured to receive signals or changes in electrical properties from the at least one force sensor (e.g., at least one force sensor 204, at least one force sensor 208, at least one force sensor 209 (as shown and described with respect to FIGS. 2A-E), and/or force sensor 704) and output touch force data (e.g., data of touch force information) to the processor 430. The touch force data may include information associated with an amount of force detected by each of the at least one force sensor (e.g., 204, 208, 209, and/or 704). In some embodiments, the touch force data obtained from the at least one force sensor (e.g., 204, 208, 209 and/or 704) does not include any touch location information. Further, in some embodiments, the touch force data obtained from the at least one force sensor (e.g., 204, 208, 209, and/or 704) includes information insufficient to determine an accurate touch location.

As shown in FIG. 4, the processor 430 is configured to receive (e.g., concurrently receive, substantially concurrently receive, simultaneously receive, substantially simultaneously receive, receive in real-time, receive in substantially real-time, and/or the like) touch location data from the touchscreen controller 410 and touch force data from the force sensor controller 420 and/or a controller 720 of a stylus 701. The processor 430 is configured to perform any of various operations based on the touch location data and the touch force data, such as operations disclosed throughout. Likewise, the processor 430 is configured to perform any of various operations (e.g., modifying, outputting, synchronizing data with other data, time-stamping, filtering, ignoring, sampling, averaging, aggregating, associating data with other data, comparing data against other data (e.g., a portion of the touch location data, a portion of the touch force data, other received data, data stored in a non-transitory computer readable medium, or the like), etc.) on the touch location data and the touch force data, and likewise, the processor 430 is configured to perform any of various operations based on the operated on touch location data and the touch force data.

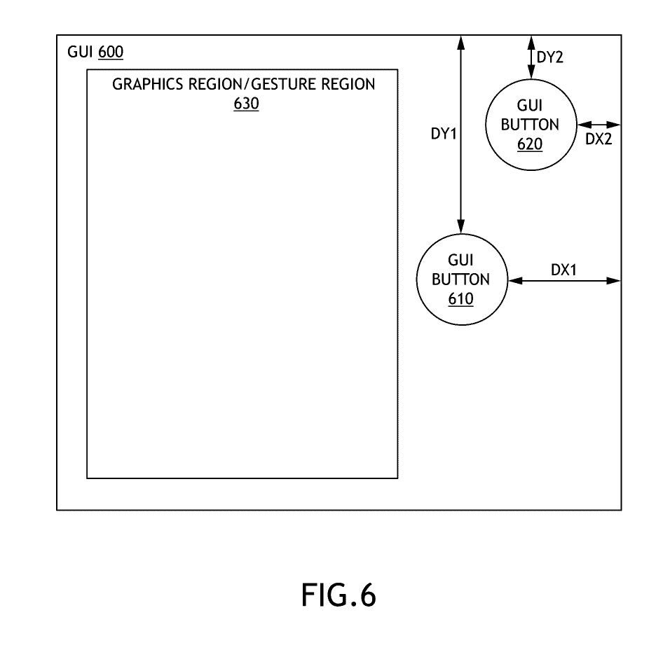

In one embodiment, the touchscreen display device 401 may include GUI software stored in a non-transitory processor-readable medium (e.g., memory 440 and/or storage 450). The processor 430 may be configured to execute instructions of the GUI software to perform various operations. The GUI software may comprise one or more software applications or computer code stored in a non-transitory computer-readable medium configured for performing various instructions or operations when executed by the processor 430. For example, execution of the GUI software by the processor 430 may cause the processor 430 to output graphical data to the display 203. Execution of the GUI software by the processor 430 may cause the processor 430 to output graphical data associated with any of various systems or devices (e.g., a radio tuning system, a flight management system (FMS), computing device 470, etc.) to be displayed to the user, for example, as GUI 600 (as shown in and described with respect to FIG. 6). The display 203 may display images corresponding to the graphical data. Further, in another embodiment, the computing device 470 may include GUI software stored in a non-transitory processor-readable medium, and a processor of the computing device 470 may be configured to execute the GUI software.

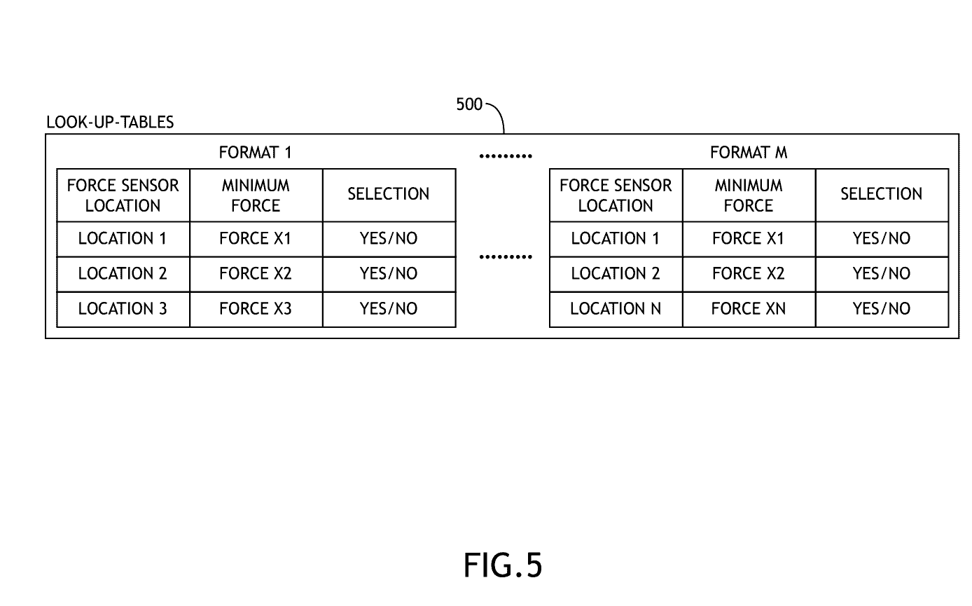

The processor 430 may be configured to determine whether to accept a touch input (e.g., a GUI button press or a touch gesture) as a selection based on touch location information, touch force information, touch input type, and/or data obtained by accessing a data structure (e.g., look-up tables 500, as shown in and described with respect to FIG. 5) to prevent inadvertent selections and/or activations. The processor 430 may determine a type of touch input based on touch location information and/or an access of data of a data structure (e.g., look-up tables 500, as shown in and described with respect to FIG. 5). For example, the processor 430 may determine that a touch input is a gesture based on a stream of touch location data received from the touchscreen controller 410 that is indicative of a gesture. Additionally, the processor 430 may determine whether a touch input is a GUI button press or a gesture based at least on a location of the touch location data and an access of data of a data structure (e.g., look-up tables 500, as shown in and described with respect to FIG. 5), such as by accessing a data structure to determine whether touch location data is associated with a GUI button (e.g., 610 or 620) or a graphics region or a gesture region (e.g., 630). For example, when a user performs a touch input (e.g., presses a GUI button (e.g., 610 or 620) displayed by the touchscreen display device 401 or performs a gesture), the processor 430 may determine whether to accept the touch input as a selection based on whether a touch force associated with the touch input exceeds an activation force threshold associated with a determined touch location(s) of the touch input. In some embodiments, the activation force threshold is fixed or variable (e.g., dynamically controllable) based on a location(s) of the touchscreen. In one embodiment, the processor 430 is configured to access (e.g., read data from and/or write data to) a data structure (e.g., look-up tables 500, as shown in and described with respect to FIG. 5) stored in a non-transitory computer readable medium (e.g., memory 440 and/or storage 450) to look up predetermined activation force thresholds associated with a detected touch input and a detected touch location. For example, an activation force near an edge of the touchscreen display may be less than an activation force near the center of the touchscreen display. Further, for example, the processor 430 may require a particular minimum force (e.g., 50 gram-force, 80 gram-force, or any other suitable force) for a button selection and a lesser minimum force (e.g., 5 gram-force, 10 gram-force, or any other suitable force) for a gesture. Additionally, the touchscreen display device 401 may be calibrated to have an effective uniform activation touch force (or any other desired distribution of fixed (e.g., predetermined) or variable (e.g., dynamically adjustable, such as user programmable or process adjustable) activation touch forces) across the entire display surface; such effective uniform activation touch force overcomes a major deficiency with current touchscreens.

Additionally, the processor 430 may be configured to filter out environmental vibrations (e.g., vibrations caused by a vehicle (such as an aircraft or automobile)) from the force sensor data so that environmental vibrations are not misinterpreted as a user's touch force. In one embodiment, if the all of the force sensors (e.g., 204, 208, 209, and/or 704) detect a same amount of force, the processor 430 may filter out the detected, same amount of force that may be indicative of environmental vibration. In another embodiment, if some or all of the force sensors (e.g., 204, 208, 209, and/or 704) detect amounts of force that are inconsistent with a typical pattern of a user touch input, the processor 430 may filter out some or all of the detected amounts of force from the sensor force data. Additionally, the processor 430 may be communicatively coupled to another force sensor (not configured to detect user touch force in the touchscreen display device 401, but rather configured to detect environmental vibrations) located elsewhere in the touchscreen display device 401 or located elsewhere in the system (e.g., elsewhere in a vehicle) to detect environmental forces acting on the force sensors (e.g., 204, 208, 209, and/or 704), and the processor 430 may filter out the forces detected by the other force sensor from force sensor data detected by the force sensors (e.g., 204, 208, 209, and/or 704). Further, for example, force sensor data from the force sensor controller 420 and/or controller 720 of a stylus 701 may be ignored when the processor 430 does not receive touch location data from the touchscreen controller 410.

For example, if a touch location is at a GUI button, the processor 430 may require that a user apply an amount of force that is greater than an activation force threshold to prevent inadvertent activation of the GUI button. Additionally, for example, if a touch location is in a map area, the required minimum force may be less (e.g., much less) to allow a user to easily execute a gesture (e.g., pinch or zoom).

Still referring to FIG. 4, the computing device 470 may include at least one processor, memory, storage, at least one input device, at least one output device, at least one input/output device, an antenna, a transmitter and/or receiver, and/or other components typically found in a computing device. Some or all of the components of the computing device may be communicatively coupled.

Referring now to FIG. 5, an exemplary data structure of one embodiment is shown. The data structure is stored in a non-transitory computer readable medium (e.g., memory 440, storage 450, other memory, other storage, or the like). As shown in FIG. 5, the data structure is implemented as look-up tables 500; however, in other embodiments, the data structure may be implemented as any suitable data structure or combination of data structures, such as at least one database, at least one list, at least one linked list, at least one table, at least one array, at least one record, at least one object, at least one set, at least one tree, a combination thereof, or the like. The data structure may be accessed (e.g., for read or write operations) by a processing element (e.g., touchscreen controller 410, force sensor controller 420, processor 430, a processor of computing device 470, and/or the like).

As shown in FIG. 5, the look-up tables 500 may include information of one or a plurality of formats (e.g., 1 . . . M). The information contained in the look-up tables 500 may include force sensor location, touch location information, minimum force for activation (e.g., an activation force threshold), selection information (e.g., selected or unselected), touch input type (e.g., GUI button press, touch gesture (e.g., pinch, zoom, rotate, drag, pan, or the like), or the like), as well as other information. Each of the plurality of formats may represent a different profile of information for any of various GUI content types (e.g., GUI button 610 or 620, graphics region/gesture region 630, the type of content (e.g., FMS content, map content, weather content, radio tuner content, etc.) displayed on the GUI), an individualized profile for a particular user interfacing with the touchscreen display device 401, and/or any of various vehicle conditions (e.g., stationary, cruise, landing, take-off, speed, weather conditions, turbulence, accelerating, braking, road conditions, and/or the like).

Referring now to FIG. 6, a view of an exemplary graphical user interface (GUI) 600 displayed by a touchscreen display device (e.g., 100, 200A, 200B, 200C, 200D, 200E, or 401) of one embodiment is shown. The GUI 600 may include any of various graphical content, such as images, icons, GUI buttons (e.g., 610 and 620), graphics region or gesture region (e.g., graphics region/gesture region 630), or the like. For example, different graphical content may have different touch formats having different profiles, which, for example, may include different activation force thresholds based on a location of the graphical content, the type of graphical content, and/or the like. For example, GUI button 620 may have a lesser activation force threshold than GUI button 610 as GUI button 620 is closer to the edge of the touchscreen display device (e.g., 401). Additionally, for example, where graphics region/gesture region 630 is intended as a region of the touchscreen display device (e.g., 401) for detecting touch gestures, graphics region/gesture region 630 may have a lesser activation force threshold than GUI buttons 610, 620. As displayed content of the GUI 600 changes, the touch formats and profiles associated with the currently displayed content may also change.

Referring now to FIG. 7A, an exemplary stylus 701 of one embodiment is shown. The stylus 701 includes a force sensor 704. The stylus 701 may include other components, such as components shown in FIG. 7B. The stylus 701 is configured to be manipulated by a user to interface with a touchscreen display device (e.g., 100, 200A, 200B, 200C, 200D, 200E, 401). The force sensor 704 of the stylus 701 may detect an amount of force when the stylus 701 is pressed against a user-interfaceable surface of the touchscreen display device. The stylus 701 may further be configured to transmit force sensor data to the touchscreen display device in real time.

Referring now to FIG. 7B, the stylus 701 may include a force sensor 704, a controller 720 (e.g., a force sensor controller), a transmitter 703, and a power supply 702. The force sensor 704 may be implemented as any suitable force sensor, such as a solid-state piezoelectric force sensor, a conductive polymer force sensor, or the like. The controller 720 is configured to receive signals or changes in electrical properties from the force sensor 704 and output touch force data (e.g., data of touch force information) to the transmitter 703 for transmission to the touchscreen display device (e.g., to a receiver of the touchscreen display device 401 which routes the touch force data to the processor 430). The touch force data may include information associated with an amount of force detected by the force sensor 704. The power supply 702 may be implemented as a battery (e.g., a rechargeable battery).

While FIGS. 7A-B depict the stylus 701 of one embodiment, other embodiments may include any suitable user manipulatable device (e.g. a glove, a variant of the stylus 701, or the like) that includes a force sensor and means for communicating force sensor data to a touchscreen display device (e.g., 401). In some embodiments, a user manipulatable device (such as the stylus 701) may be omitted.

Some embodiments include a method of manufacturing (e.g., assembling or installing components of) a touchscreen display device (e.g., 100, 200A, 200B, 200C, 200D, 200E, or 401). For example, a method may include providing at least one processing element, providing a touchscreen sensor, providing at least one force sensor, and providing a display element. In one embodiment, the at least one processing element is configured to receive touch location data obtained from a touchscreen sensor of a touch screen display device, the touch location data including information of a location of a user's touch or near touch of the touchscreen display device. The at least one processing element may further be configured to receive force data obtained from at least one force sensor of the touch screen display device, the force data including information of an amount of force detected by one or more of the at least one force sensor. The at least one processing element may also be configured to perform at least one operation based on the touch location data and the force data. As described herein, “providing” may include placing, positioning, fastening, affixing, gluing, welding, soldering, securing, and/or the like, such as through the use of screws, bolts, clips, pins, rivets, adhesives, solder, tape, computer controlled equipment (such as robotic assembly devices, assembly line equipment, or the like) configured to position and/or place various components, or the like. Further, the method may include providing any of various components disclosed throughout.

As used throughout, “at least one” means one or a plurality of; for example, “at least one” may comprise one, two, three, . . . , one hundred, or more. Similarly, as used throughout, “one or more” means one or a plurality of; for example, “one or more” may comprise one, two, three, . . . , one hundred, or more.

In the present disclosure, the methods, operations, and/or functionality disclosed may be implemented as sets of instructions or software readable by a device. Further, it is understood that the specific order or hierarchy of steps in the methods, operations, and/or functionality disclosed are examples of exemplary approaches. Based upon design preferences, it is understood that the specific order or hierarchy of steps in the methods, operations, and/or functionality can be rearranged while remaining within the disclosed subject matter. The accompanying claims may present elements of the various steps in a sample order, and are not necessarily meant to be limited to the specific order or hierarchy presented.

It is believed that embodiments of the present disclosure and many of its attendant advantages will be understood by the foregoing description, and it will be apparent that various changes can be made in the form, construction, and arrangement of the components thereof without departing from the scope of the disclosure or without sacrificing all of its material advantages. The form herein before described being merely an explanatory embodiment thereof, it is the intention of the following claims to encompass and include such changes.

What is claimed is:

1. A system, comprising:
a touchscreen sensor of a touchscreen display device;
at least one force sensor;
a display element of the touchscreen display device; and
at least one processing element configured to:
receive touch location data obtained from the touchscreen sensor, the touch location data including information of a location of a user's touch or near touch of a user-interfaceable surface of the touchscreen display device;
receive force data obtained from the at least one force sensor, the force data including information of an amount of force detected by one or more of the at least one force sensor; and
perform at least one operation based at least on the touch location data and the force data.

2. The system of claim 1, wherein the touchscreen display device is a zero force touchscreen display device.

3. The system of claim 1, wherein the at least one processing element is further configured to:
determine a type of touch input based at least on the touch location information.

4. The system of claim 3, wherein one or more of the at least one force sensor are implemented in the touchscreen display device, wherein the at least one processing element is further configured to:
determine a minimum activation force based at least on the touch location information and the type of touch input.

5. The system of claim 4, wherein a minimum activation force for a touch gesture is less than a minimum activation force for a graphical user interface button selection.

6. The system of claim 1, wherein one or more of the at least one force sensor are implemented in the touchscreen display device, wherein the at least one processing element is further configured to:
determine a minimum activation force based at least on the touch location information.

7. The system of claim 6, wherein a minimum activation force near an edge of the user-interfaceable surface of the touchscreen display device is less than a minimum activation force near a center of the user-interfaceable surface of the touchscreen display device.

8. The system of claim 6, wherein the at least one processing element is further configured to:
determine whether the amount of force detected by the at least one force sensor exceeds the minimum activation force; and
execute a user selection upon a determination that the amount of force detected by the at least one force sensor exceeds the minimum activation force.

9. The system of claim 1, wherein the at least one processing element is further configured to:
filter out environmental vibrations from the force data.

10. The system of claim 1, wherein the system is a vehicular system, wherein the touchscreen sensor, the at least one force sensor, the display element, and the at least one processing element are implemented in a vehicle, wherein the at least one processing element is configured to utilize the touch location data and the force data to reduce inadvertent selections and to improve detection of gestures performed with less force than a minimum required force for a graphical user interface button selection.

11. The system of claim 1, wherein the touchscreen sensor and the display element are integrated in a layer.

12. The system of claim 1, wherein the at least one force sensor is implemented in the touchscreen display device, wherein the at least one force sensor is a plurality of force sensors, and wherein at least some of the plurality of force sensors are located below the display element.

13. The system of claim 1, wherein the at least one force sensor is implemented in the touchscreen display device, wherein the at least one force sensor is a plurality of force sensors, and wherein at least some of the plurality of force sensors are located above and below the display element.

14. The system of claim 1, wherein the at least one force sensor is implemented in the touchscreen display device, wherein the at least one force sensor is a plurality of force sensors, wherein the display element is an emissive display element, and wherein at least some of the plurality of force sensors are located below a viewable portion of the emissive display element.

15. The system of claim 1, wherein the at least one force sensor is implemented in the touchscreen display device, wherein the at least one force sensor is a plurality of force sensors, wherein the display element is a transmissive display element, and wherein at least some of the plurality of force sensors are located below edges of the transmissive display element.

16. The system of claim 1, wherein the at least one processing element comprises at least one touchscreen controller, at least one force sensor controller, and at least one processor.

17. The system of claim 1, wherein the at least one force sensor is implemented in the touchscreen display device, wherein touchscreen display device is calibrated to have a uniform activation touch force across the user-interfaceable surface of the touchscreen display device.

18. The system of claim 1, wherein a force sensor of the at least one force sensor is implemented in a user manipulatable device.

19. A method, comprising:
receiving touch location data obtained from a touchscreen sensor of a touchscreen display device, the touch location data including information of a location of a user's touch or near touch of a user-interfaceable surface of the touchscreen display device;
receiving force data obtained from at least one force sensor, the force data including information of an amount of force detected by one or more of the at least one force sensor; and
performing at least one operation based at least on the touch location data and the force data.

20. A method, comprising:
providing at least one processing element configured to: receive touch location data obtained from a touchscreen sensor of a touchscreen display device, the touch location data including information of a location of a user's touch or near touch of a user-interfaceable surface of the touchscreen display device; receive force data obtained from at least one force sensor, the force data including information of an amount of force detected by one or more of the at least one force sensor; and perform at least one operation based at least on the touch location data and the force data; and
providing the touchscreen sensor;
providing the at least one force sensor; and
providing a display element.
